(19) United States
(12) Patent Application Publication
(10) Pub. No.: US 2025/0293363 A1
(43) Pub. Date: Sep. 18, 2025

(54) POWER STORAGE DEVICE AND VEHICLE

(71) Applicants: TOYOTA JIDOSHA KABUSHIKI KAISHA, Aichi-ken (JP); TOYOTA BATTERY CO., LTD., Shizuoka (JP)

(72) Inventors: Kazuhito KATO, Toyota-shi (JP); Yoshiro OBAYASHI, Toyota-shi (JP); Yosuke SHIMURA, Nagakute-shi (JP); Kenta MIYAHARA, Toyohashi-shi (JP); Takuya NOGUCHI, Toyota-shi (JP); Ryutaro SUZUKI, Hamamatsu-shi (JP); Yuji KATAYAMA, Okazaki-shi (JP); Masaya OGURA, Hamamatsu-shi (JP)

(21) Appl. No.: 19/048,962

(22) Filed: Feb. 10, 2025

(30) Foreign Application Priority Data
Mar. 13, 2024 (JP) 2024-039262

(51) Int. Cl. H01M 50/209; H01M 50/249; H01M 50/367; H01M 50/502

(52) U.S. Cl. CPC H01M 50/209; H01M 50/249; H01M 50/367; H01M 50/502; H01M 2220/20

(57) ABSTRACT

A power storage device configured to store electric power includes a casing, one or more cell connected bodies, and a base member on which the one or more cell connected bodies are carried. Each of the one or more cell connected bodies includes a plurality of power storage cells and a connection portion that electrically connects the power storage cells to each other. The one or more cell connected bodies and the base member are accommodated in the casing.

### CROSS REFERENCE TO RELATED APPLICATIONS

This nonprovisional application is based on Japanese Patent Application No. 2024-039262 filed with the Japan Patent Office on Mar. 13, 2024, the entire contents of which are hereby incorporated by reference.

### BACKGROUND

### Field

The present disclosure relates to a power storage device and a vehicle including the power storage device.

### Description of the Background Art

Japanese National Patent Publication No. 2023-502457 discloses a battery (power storage device) in a shape of a parallelepiped having a length L from 400 mm to 2500 mm and having a ratio (L/H) of length L to a width H of 4 to 21.

### SUMMARY

In the power storage device described in Japanese National Patent Publication No. 2023-502457, a plurality of electrode core sets aligned in a line as being connected in series are arranged in a casing (housing). In this power storage device, an electrode core set corresponds to a power storage cell. A connected body where a plurality of power storage cells are connected in a line is referred to as a “cell connected body” below.

Since the cell connected body includes the power storage cells high in rigidity and a connection portion low in rigidity, it is difficult to introduce the cell connected body into the casing. For example, stress may be produced in the connection portion in introduction of the cell connected body into the casing and the connection portion may be damaged.

The present disclosure was made to solve the problem above, and an object thereof is to provide a power storage device and a vehicle constructed such that a cell connected body is readily introduced in a casing.

According to a form according to a first point of view of the present disclosure, a power storage device shown below is provided.

(Clause 1) A power storage device configured to store electric power includes a casing, one or more cell connected bodies, and a base member on which the one or more cell connected bodies are carried. Each of the one or more cell connected bodies includes a plurality of power storage cells and a connection portion that electrically connects the power storage cells to each other. The one or more cell connected bodies and the base member are accommodated in the casing.

According to the construction, the one or more cell connected bodies as being carried on the base member can be introduced into the casing. The cell connected body is thus more readily introduced into the casing.

(Clause 2) In the power storage device described in Clause 1, the casing is in a shape of a parallelepiped having a longitudinal direction extending in a connection direction of each of the one or more cell connected bodies.

In the power storage device, by sliding the base member on which the one or more cell connected bodies are carried toward the casing in the shape of the parallelepiped, the one or more cell connected bodies together with the base member can be inserted in the casing.

(Clause 3) In the power storage device described in Clause 2, the casing is provided with four surfaces that extend in the connection direction of each of the one or more cell connected bodies and two surfaces that cover ends of the one or more cell connected bodies. The four surfaces include first opposing surfaces which are a pair of surfaces opposed to each other and second opposing surfaces which are opposing surfaces larger in area than the first opposing surfaces. The base member is arranged on one of the first opposing surfaces.

As the base member is arranged on the surface small in area as above, a dimension of the base member is more readily made smaller.

(Clause 4) In the power storage device described in any one of Clauses 1 to 3, the one or more cell connected bodies are bonded to the base member.

According to the construction, movement of the one or more cell connected bodies away from the base member can be suppressed when the one or more cell connected bodies as being carried on the base member are introduced into the casing.

(Clause 5) In the power storage device described in any one of Clauses 1 to 3, the one or more cell connected bodies are slidable in a connection direction thereof with respect to the base member.

According to the construction, after the one or more cell connected bodies as being carried on the base member are introduced into the casing, the one or more cell connected bodies can be slid in the connection direction with respect to the base member.

(Clause 6) In the power storage device described in any one of Clauses 1 to 5, the base member is in a shape of a flat plate.

The base member is readily manufactured. According to the construction, manufacturing cost can be reduced.

(Clause 7) In the power storage device described in any one of Clauses 1 to 5, the base member is in a shape having a U-shaped cross-section.

By introducing the one or more cell connected bodies in the recess (a portion in the U shape) in the base member, the one or more cell connected bodies as being carried on the base member are more readily appropriately introduced in the casing.

(Clause 8) In the power storage device described in any one of Clauses 1 to 5, a surface of the base member on which the one or more cell connected bodies are placed is provided with one or more recesses which a part of the one or more cell connected bodies enters.

By introducing the one or more cell connected bodies in the one or more recesses, the one or more cells connected bodies as being carried on the base member are more readily appropriately introduced in the casing.

(Clause 9) In the power storage device described in any one of Clauses 1 to 5, the one or more cell connected bodies include a first cell connected body and a second cell connected body electrically connected to each other. A surface of the base member on which the one or more cell connected bodies are placed is provided with a first recess which a part of the first cell connected body enters and a second recess which a part of the second cell connected body enters.

By introducing the first cell connected body and the second cell connected body into the first recess and the second recess, respectively, the first cell connected body and the second cell connected body as being carried on the base member are more readily appropriately introduced in the casing.

(Clause 10) In the power storage device described in any one of Clauses 1 to 9, a surface of the base member opposite to a surface of the base member on which the one or more cell connected bodies are placed is provided with a linear projection that extends in a connection direction of each of the one or more cell connected bodies.

The base member more readily linearly moves over an inner surface of the casing with the linear projection being interposed. The one or more cell connected bodies as being carried on the base member are thus more readily appropriately introduced in the casing.

(Clause 11) In the power storage device described in any one of Clauses 1 to 9, a surface of the base member opposite to a surface of the base member on which the one or more cell connected bodies are placed is provided with a sheet that lowers a coefficient of friction against an inner surface of the casing.

According to the sheet, the coefficient of friction between the base member and the inner surface of the casing is lowered. Therefore, the base member more readily slides over the inner surface of the casing. The one or more cell connected bodies as being carried on the base member are thus more readily appropriately introduced in the casing.

(Clause 12) In the power storage device described in any one of Clauses 1 to 11, the base member is provided with a flow path through which gas generated from at least one of the plurality of power storage cells is emitted.

According to the construction, gas generated from the power storage cell is more readily appropriately emitted.

According to a form according to a second point of view of the present disclosure, a vehicle shown below is provided.

(Clause 13) The vehicle includes the power storage device according to any one of Clauses 1 to 12.

The vehicle includes the power storage device constructed such that the cell connected body is more readily introduced in the casing.

The foregoing and other objects, features, aspects, and advantages of this disclosure will become more apparent from the following detailed description of this disclosure when taken in conjunction with the accompanying drawings.

### BRIEF DESCRIPTION OF THE DRAWINGS

FIG. 1 is a diagram for illustrating a construction of a power storage device according to an embodiment of the present disclosure.

FIG. 2 is a perspective view showing as being enlarged, inside of a casing of the power storage device shown in FIG. 1.

FIG. 3 is a diagram for illustrating a construction of each cell connected body shown in FIG. 1.

FIG. 4 is an exploded perspective view of a power storage cell included in each cell connected body shown in FIG. 1.

FIG. 5 is a cross-sectional view along the line V-V in FIG. 1.

FIG. 6 is a cross-sectional view along the line VI-VI in FIG. 1.

FIG. 7 is a diagram for illustrating functions and effects achieved by the power storage device according to the embodiment of the present disclosure.

FIG. 8 is a diagram showing a first modification of the power storage device shown in FIG. 1.

FIG. 9 is a cross-sectional view along the line IX-IX in FIG. 8.

FIG. 10 is a diagram showing a second modification of the power storage device shown in FIG. 1.

FIG. 11 is a cross-sectional view corresponding to FIG. 5, of the power storage device according to the second modification.

FIG. 12 is a cross-sectional view corresponding to FIG. 6, of the power storage device according to the second modification.

FIG. 13 is a diagram showing a third modification of the power storage device shown in FIG. 1.

FIG. 14 is a diagram showing a fourth modification of the power storage device shown in FIG. 1.

FIG. 15 is a diagram showing a fifth modification of the power storage device shown in FIG. 1.

FIG. 16 is a diagram showing a sixth modification of the power storage device shown in FIG. 1.

FIG. 17 is a diagram showing a seventh modification of the power storage device shown in FIG. 1.

FIG. 18 is a diagram showing an eighth modification of the power storage device shown in FIG. 1.

FIG. 19 is a cross-sectional view along the line XIX-XIX in FIG. 18.

FIG. 20 is a diagram showing an exemplary power storage module including a plurality of batteries.

FIG. 21 is a diagram showing an exemplary vehicle on which the power storage module shown in FIG. 20 is mounted.

### DESCRIPTION OF THE PREFERRED EMBODIMENTS

An embodiment of the present disclosure will be described in detail with reference to the drawings. The same or corresponding elements in the drawings have the same reference characters allotted and description thereof will not be repeated. In each figure referred to below, among an X axis, a Y axis, and a Z axis orthogonal to one another, the X axis represents a first in-plane direction (for example, a length direction) of a battery, the Y axis represents a second in-plane direction (for example, a width direction) of the battery, and the Z axis represents a height direction of the battery. A direction indicated by an arrow along each of the X axis, the Y axis, and the Z axis is expressed with “+” below, and a direction opposite thereto is expressed with “−”.

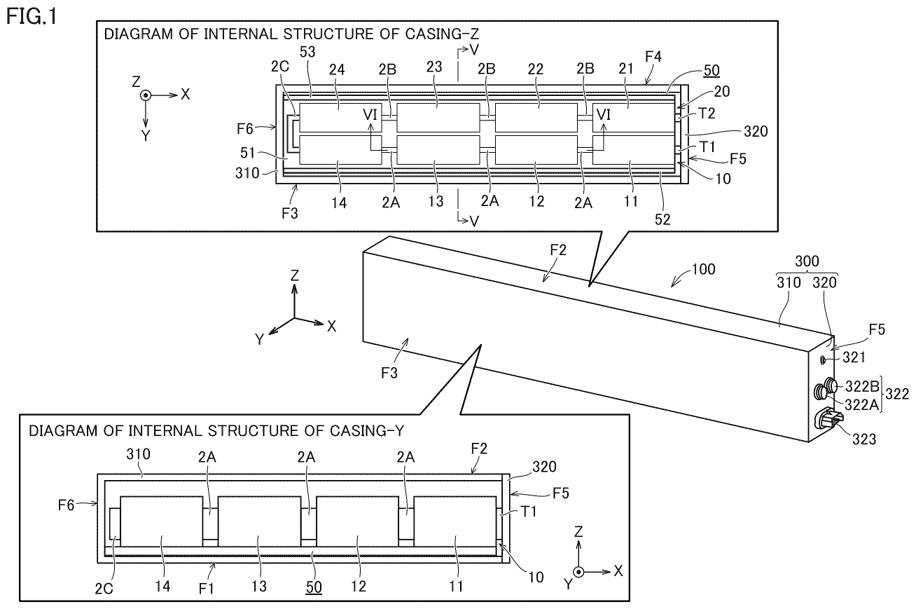

FIG. 1 is a diagram for illustrating a construction of a power storage device according to this embodiment. A “diagram of internal structure of casing −Z” in FIG. 1 is a diagram of components in the casing viewed from a +Z side. A “diagram of internal structure of casing −Y” is a diagram of components in the casing viewed from a +Y side.

The power storage device according to this embodiment is a battery 100 shown in FIG. 1. Battery 100 is a secondary battery such as a lithium ion battery, a nickel metal hydride battery, or a sodium ion battery. An exemplary lithium ion battery includes an LFP battery in which lithium iron phosphate is adopted as a positive electrode active material or a ternary battery in which nickel manganese cobalt (NMC) is adopted as the positive electrode active material. A type of the secondary battery may be a liquid secondary battery or an all-solid secondary battery. Though details will be described later, battery 100 includes a plurality of power storage cells each of which functions as the secondary battery. Battery 100 may include only power storage cells of the same type (for example, only LFP batteries) or power storage cells different in type (for example, the LFP battery and the ternary battery).

Battery 100 includes a casing 300. Casing 300 has a geometry in a shape of a parallelepiped. Casing 300 is provided with a pair of surfaces F1 and F2 (first opposing surfaces) opposed to each other in a Z direction, a pair of surfaces F3 and F4 (second opposing surfaces) opposed to each other in a Y direction, and surfaces F5 and F6 located at respective ends in an X direction (end surfaces in the X direction). Each of surfaces F1 and F2 is smaller in area than each of surfaces F3 and F4. A length (a dimension in the X direction) of casing 300 is longer than a width (a dimension in the Y direction) of casing 300. The length of casing 300 may be not smaller than 250 mm and not larger than 5000 mm, and it is, for example, approximately 1000 mm. The width of casing 300 may be not smaller than 10 mm and not larger than 1250 mm, and it is, for example, approximately 50 mm. A ratio of the length of casing 300 to the width of casing 300 may be not lower than 4 and not higher than 25. A height (a dimension in the Z direction) of casing 300 may be not smaller than 10 mm and not larger than 1250 mm, and it is, for example, approximately 100 mm. The dimension of casing 300 is not limited as above.

Casing 300 includes a main body 310 and a lid body 320. Main body 310 is a hollow housing with bottom, for example, provided with an opening in an end surface on a +X side, and cell connected bodies 10 and 20 are accommodated therein. Lid body 320 is a plate-shaped member (cover member) with a geometry corresponding to the opening in main body 310, and closes the opening on the +X side in main body 310. Main body 310 and lid body 320 may be formed of the same material or different materials. For example, metal can be adopted as the material for each of main body 310 and lid body 320. Casing 300 may be a casing made of aluminum. These materials can be changed as appropriate. For example, lid body 320 may be formed of an insulating material.

Cell connected body 10 includes four power storage cells 11 to 14 and three connection portions 2A that electrically connect the power storage cells to one another. Power storage cells 11 to 14 are connected in a line in the X direction in casing 300. Cell connected body 20 includes four power storage cells 21 to 24 and three connection portions 2B that electrically connect the power storage cells to one another. Power storage cells 21 to 24 are connected in a line in the X direction in casing 300. Cell connected body 10 and cell connected body 20 are thus arranged in parallel to the X direction. Each of surfaces F1 to F4 of casing 300 extends in a connection direction (X direction) of each of cell connected bodies 10 and 20. Each of surfaces F5 and F6 of casing 300 covers an end in the X direction of cell connected bodies 10 and 20. Each power storage device included in cell connected bodies 10 and 20 is configured to store electric power.

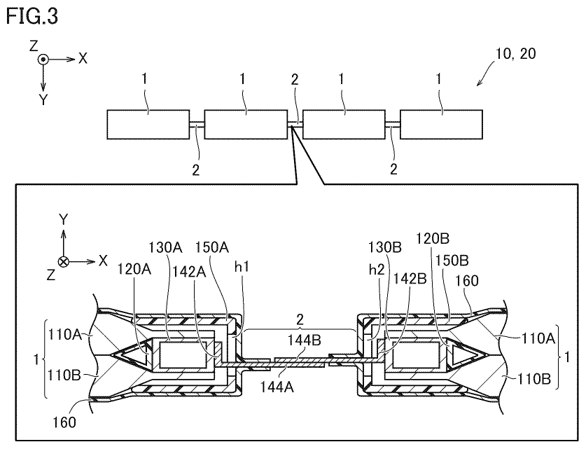

In casing 300 of battery 100, cell connected body 10 and cell connected body 20 are electrically connected to each other. Specifically, as shown in FIG. 1, an end (power storage cell 14) on an −X side of cell connected body 10 and an end (power storage cell 24) on the −X side of cell connected body 20 are electrically connected to each other, for example, through a U-shaped connection portion 2C in casing 300. Connection portion 2C has a cross-section in a U shape, whereas each of connection portions 2A and 2B has a cross-section in an I shape. Connection portion 2C is basically similar in structure to connection portion 2A or 2B except that it is formed in a different shape. Connection portion 2C may be an integrally formed article or a composite of a plurality of separately formed components. For example, connection portion 2C may be formed from connection through a conductive material (beam portion), of a protruding portion 144B (FIG. 3) that protrudes from power storage cell 14 and a protruding portion 144B (FIG. 3) that protrudes from power storage cell 24 to each other. Protruding portion 144B will be described later.

Cell connected bodies 10 and 20 are arranged such that positions of the power storage cells are aligned and positions of the connection portions are aligned. Power storage cells 11, 12, 13, and 14 included in cell connected body 10 are superimposed on power storage cells 21, 22, 23, and 24 included in cell connected body 20 in the Y direction, respectively. In other words, all power storage cells included in cell connected body 10 are arranged as being opposed in the Y direction to any power storage cells included in cell connected body 20, respectively. An end (power storage cell 11) on the +X side of cell connected body 10 is connected to lid body 320 with a connection terminal T1 being interposed. An end (power storage cell 21) on the +X side of cell connected body 20 is connected to lid body 320 with a connection terminal T2 being interposed.

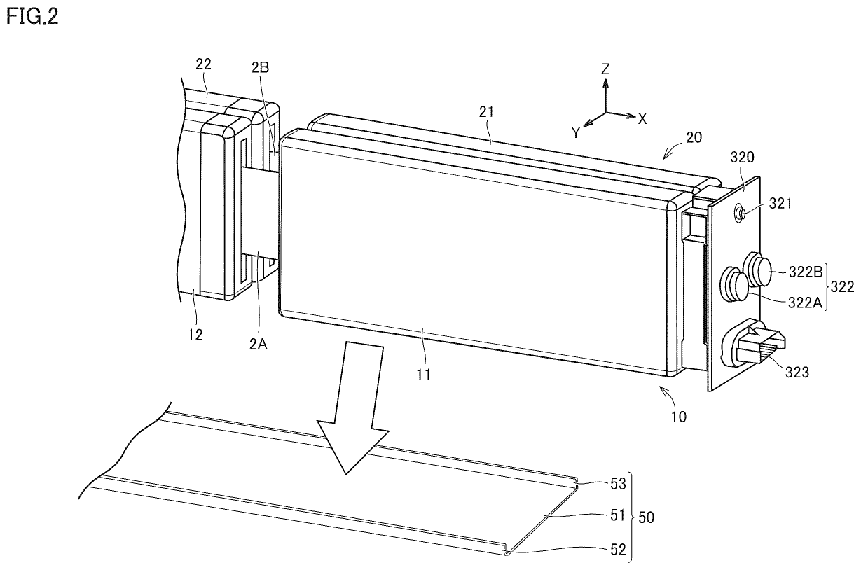

A base member 50 is further accommodated in casing 300. FIG. 2 is a perspective view showing cell connected bodies 10 and 20 and base member 50 being separate from each other.

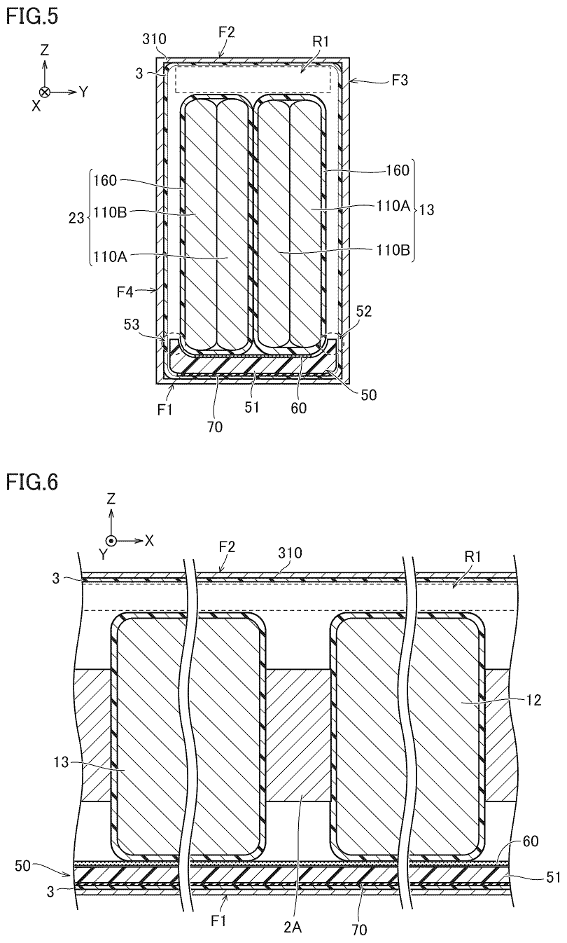

Base member 50 is formed in a U shape as shown in FIG. 2. Base member 50 includes a main body portion 51 in a shape of a plate and projections 52 and 53. Main body portion 51 is formed as being elongated in the X direction (the connection direction of each of cell connected bodies 10 and 20). Main body portion 51 is formed along cell connected bodies 10 and 20. Projections 52 and 53 are located at an end on the +Y side and an end on a −Y side of main body portion 51, respectively. Each of projections 52 and 53 is linearly formed in the X direction and projects toward the +Z side. Base member 50 is accommodated in casing 300 with cell connected bodies 10 and 20 being carried on main body portion 51. Details of base member 50 will be described later (see FIGS. 5 and 6).

Lid body 320 includes a sealing hole 321, an external terminal 322, and a connector 323. Sealing hole 321 may be a pressure regulation hole for regulation of a pressure in casing 300. Sealing hole 321 has a sealing structure, for example, with a metallic cap (outside of the casing) and a sealing member (inside of the casing). While such a sealing structure ensures hermeticity in casing 300, gas is emitted to the outside of casing 300 through sealing hole 321 when the pressure in casing 300 exceeds a prescribed level. External terminal 322 includes an electrode tab 322A joined (for example, welded with laser) to connection terminal T1 (FIG. 1) of cell connected body 10 and an electrode tab 322B joined (for example, welded with laser) to connection terminal T2 (FIG. 1) of cell connected body 20. Electrode tabs 322A and 322B are electrically connected to power storage cells 11 and 21, respectively. Each of electrode tabs 322A and 322B may be provided with an insulating sealing structure composed of ceramics, for example, around an electrode. In this embodiment, electrode tabs 322A and 322B function as a negative electrode tab and a positive electrode tab, respectively. Without being limited as such, with polarity being reversed, electrode tab 322B may serve as the negative electrode tab and electrode tab 322A may serve as the positive electrode tab. Connector 323 includes, for example, an output terminal that outputs a detection signal indicating a state (for example, a temperature of each power storage cell) in casing 300 detected by one or more sensors in casing 300 to the outside of the casing and an input terminal that receives input of a control signal from the outside of the casing to one or more devices in casing 300. For example, a temperature sensor may be provided for each power storage cell in casing 300.

In this embodiment, cell connected body 10 and cell connected body 20 are basically identical to each other in construction. Therefore, when power storage cells 11 to 14 and 21 to 24 are not distinguished, they are referred to as a “power storage cell 1” below, and when connection portions 2A and 2B are not distinguished, they are referred to as a “connection portion 2” below.

FIG. 3 is a diagram for illustrating a construction of each of cell connected bodies 10 and 20. As shown in FIG. 3, each cell connected body includes four power storage cells 1. Connection portion 2 is provided between adjacent power storage cells 1 and connection portion 2 electrically connects those power storage cells 1 to each other. Each cell connected body is constructed of power storage cells 1 and connection portions 2 that are alternately aligned. In each of cell connected bodies 10 and 20, power storage cells 1 are connected to each other through connection portion 2. Connection portion 2 is lower in rigidity than power storage cell 1. Power storage cells 11 to 14 and 21 to 24 are formed from identical power storage cells 1. By forming cell connected bodies 10 and 20 from common power storage cells 1, manufacturing of battery 100 is facilitated and manufacturing cost can be reduced.

The construction of cell connected bodies 10 and 20 is not limited to the construction above. Each cell connected body may include power storage cells different in dimension or may include power storage cells different in shape. The number of power storage cells to be accommodated in casing 300 is not limited to eight but can be varied as appropriate. The number of power storage cells included in each cell connected body may be smaller than four, may be not smaller than five and not larger than nineteen, or may be equal to or larger than twenty.

In this embodiment, power storage cell 1 is a laminated cell including one or more wound bodies. In the laminated cell, one or more wound bodies that function as an electrode assembly are covered with a laminated exterior body. FIG. 2 shows the power storage cell without the laminated exterior body. The wound body has a structure, for example, in which a positive electrode sheet and a negative electrode sheet are wound with a separator lying therebetween. Each of the positive electrode sheet and the negative electrode sheet contains an electrode foil and an active material layer.

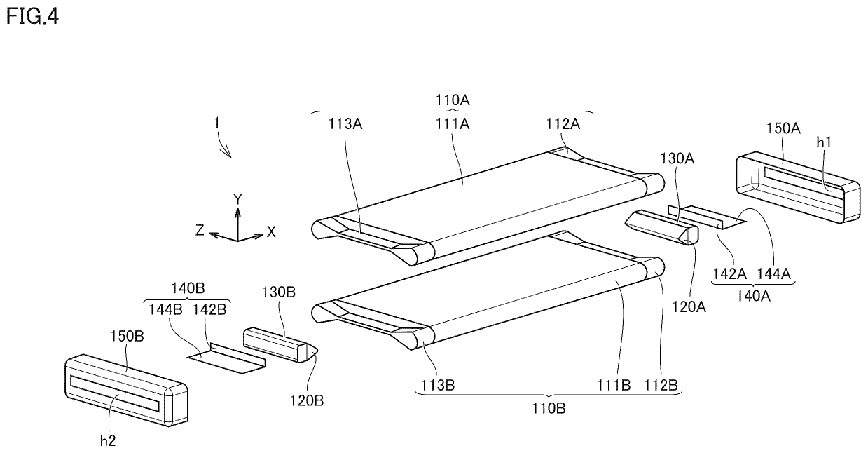

FIG. 4 is an exploded perspective view of power storage cell 1. A structure of power storage cell 1 and connection portion 2 will be described below with reference to the cross-sectional view in FIG. 3 (an X-Y cross-sectional view around connection portion 2) and FIG. 4.

As shown in FIG. 4, power storage cell 1 includes two wound bodies 110A and 110B, spacers 120A and 120B, terminal members 130A and 130B, and covers 150A and 150B.

Wound body 110A includes a coated portion 111A, an electrode tab 112A, and an electrode tab 113A. Wound body 110B includes a coated portion 111B, an electrode tab 112B, and an electrode tab 113B. Each of coated portions 111A and 111B is an area in the positive electrode sheet or the negative electrode sheet where the active material layer is provided in the electrode foil. Each of electrode tabs 112A, 112B, 113A, and 113B is an area in the positive electrode sheet or the negative electrode sheet where the electrode foil is exposed (an uncoated portion where the active material layer is not provided). Electrode tabs 112A and 112B are located at ends on the +X side of wound bodies 110A and 110B, respectively. Electrode tabs 113A and 113B are located at ends on the −X side of wound bodies 110A and 110B, respectively.

Electrode tab 112A and electrode tab 112B are arranged as being superimposed in the Y direction, and spacer 120A and terminal member 130A are provided between electrode tab 112A and electrode tab 112B (see FIG. 3). Electrode tab 113A and electrode tab 113B are arranged as being superimposed in the Y direction, and spacer 120B and terminal member 130B are provided between electrode tab 113A and electrode tab 113B (see FIG. 3).

Each of spacers 120A and 120B contains an insulating material (for example, synthetic resin) and it is insulating. Spacers 120A and 120B are each in a shape increasing in dimension in the Y direction as they are more distant from coated portions 111A and 111B (see FIG. 3). Terminal member 130A is connected to an end surface on the +X side of spacer 120A. Terminal member 130B is connected to an end surface on the −X side of spacer 120B. Each of terminal members 130A and 130B contains a conductive material (for example, metal such as aluminum or copper) and it is conductive. Wound body 110A and wound body 110B are joined to each other (for example, welded with laser) with terminal members 130A and 130B being interposed.

Each of current collection terminals 140A and 140B is a component that forms a part of connection portion 2. Current collection terminal 140A includes a support portion 142A and a protruding portion 144A. Current collection terminal 140B includes a support portion 142B and protruding portion 144B. One of current collection terminals 140A and 140B functions as a positive electrode current collection terminal and the other thereof functions as a negative electrode current collection terminal. In one example, the positive electrode current collection terminal is formed of aluminum and the negative electrode current collection terminal is formed of copper.

Each of current collection terminals 140A and 140B is formed in an L shape. Each of support portions 142A and 142B is formed in a shape of a plate on a Y-Z plane and each of protruding portions 144A and 144B is formed in a shape of a plate on an X-Z plane. Support portion 142A and protruding portion 144A may be formed separately from each other and then joined to each other, or formed as being integrated by bending. Support portion 142B and protruding portion 144B may also be formed separately from each other and then joined to each other, or formed as being integrated by bending. Support portion 142A is joined (for example, welded with laser) to an end surface on the +X side of terminal member 130A (see FIG. 3). Support portion 142B is joined (for example, welded with laser) to an end surface on the −X side of terminal member 130B (see FIG. 3).

Cover 150A covers the end (including electrode tabs 112A and 112B) on the +X side of power storage cell 1. Cover 150A is provided with a through hole h1 for protruding portion 144A. Protruding portion 144A passes through through hole h1 and protrudes on the +X side of power storage cell 1 (see FIG. 3). Cover 150B covers the end (including electrode tabs 113A and 113B) on the −X side of power storage cell 1. Cover 150B is provided with a through hole h2 for protruding portion 144B. Protruding portion 144B passes through through hole h2 and protrudes on the −X side of power storage cell 1 (see FIG. 3).

As shown in FIG. 3, in connection portion 2, protruding portion 144A of one power storage cell 1 of two adjacent power storage cells 1 is joined (for example, welded with laser) to protruding portion 144B of the other power storage cell 1. A welded portion may be protected by a tape or the like. Though not shown in FIG. 4, a laminated exterior body 160 shown in FIG. 3 is provided on a surface of each of two wound bodies 110A and 110B. Laminated exterior body 160 is, for example, a laminated film and provided on a surface of power storage cell 1.

The construction described above is merely an example of the construction of power storage cell 1 and can be modified as appropriate. For example, the number of wound bodies included in power storage cell 1 is not limited to two, and a single wound body or at least three wound bodies may be provided. A layered body (for example, a layered body in which the positive electrode sheet and the negative electrode sheet are layered with the separator lying therebetween) may be adopted as the electrode assembly, instead of the wound body.

FIG. 5 is a cross-sectional view along the line V-V in FIG. 1. FIG. 6 is a cross-sectional view along the line VI-VI in FIG. 1.

As shown in FIGS. 5 and 6, cell connected bodies 10 and 20 as being carried on base member 50 are accommodated in casing 300. An insulating layer 3 containing resin such as polyethylene terephthalate (PET) is provided on an inner surface of main body 310 of casing 300. Casing 300 and a component in casing 300 are thus electrically isolated from each other. In the battery where sufficient insulation is ensured, however, insulating layer 3 does not have to be provided. A region R1 is present between the surface on the +Z side of each power storage cell included in cell connected bodies 10 and 20 and the inner surface (top surface) of main body 310. In region R1, at least one of a heat management system (for example, a heater and/or a temperature sensor), a gas emission system (for example, a gas flow path and/or a pressure sensor), a flexible printed circuit board (FPC), and a line connected to connector 323 may be provided. A device and/or a sensor provided in region R1 may be connected to connector 323 of lid body 320.

As shown in FIG. 5, base member 50 has a cross-section in a U shape as a cross-section (Y-Z cross-section) orthogonal to the X direction. Base member 50 is formed basically in a shape of a plate. Base member 50 includes projections 52 and 53 that project from main body portion 51 toward the +Z side, in addition to main body portion 51 in the shape of the plate. Projections 52 and 53 are located on opposing sides of power storage cells 13 and 23 adjacent in the Y direction, respectively, and function to maintain power storage cells 13 and 23 at prescribed positions. Projection 52 suppresses movement of power storage cell 13 toward the +Y side. Projection 53 suppresses movement of power storage device 23 toward the −Y side.

Base member 50 contains an insulating material (for example, resin) and it is insulating. Without being limited as such, a material for base member 50 can be changed as appropriate. Base member 50 may contain metal. Main body portion 51 and projections 52 and 53 may be an integrally formed article or such a composite that a plurality of separately formed members are joined to one another. Main body portion 51 and projections 52 and 53 may be formed of the same material or different materials.

A portion between projection 52 and projection 53 (above main body portion 51) in base member 50 is provided with a recess (specifically, a groove in the X direction). While the end on a −Z side of each of power storage cells 13 and 23 is located in this recess, power storage cells 13 and 23 are bonded to a surface on the +Z side of main body portion 51 with an adhesive 60. Adhesive 60 may be higher in thermal conductivity than main body portion 51. Base member 50 is provided with a sheet 70 on a surface on the −Z side of main body portion 51. A coefficient of friction between sheet 70 and the inner surface of main body 310 is lower than the coefficient of friction between main body portion 51 and the inner surface of main body 310. Therefore, sheet 70 serves to lower the coefficient of friction between base member 50 and the inner surface of casing 300. A surface on the +Z side of base member 50 (the surface on which cell connected bodies 10 and 20 are placed) may be referred to as a “first surface” and a surface on the −Z side of base member (the surface opposite to the surface on which cell connected bodies 10 and 20 are placed) may be referred to as a “second surface” below.

FIG. 5 representatively shows only a pair of power storage cells 13 and 23 adjacent in the Y direction. FIG. 6 representatively shows only a pair of power storage cells 12 and 13 adjacent in the X direction. As shown in FIG. 1, main body portion 51 is a plate-shaped member that extends over substantially the entire region in the X direction of main body 310, and each of projections 52 and 53 is a linear projection that extends over substantially the entire region in the X direction of main body 310. All power storage cells included in cell connected bodies 10 and 20 are bonded to main body portion 51. Projection 52 is located on the +Y side of all power storage cells included in cell connected body 10 and suppresses movement of those power storage cells toward the +Y side. Projection 53 is located on the −Y side of all power storage cells included in cell connected body 20 and suppresses movement of those power storage cells toward the −Y side.

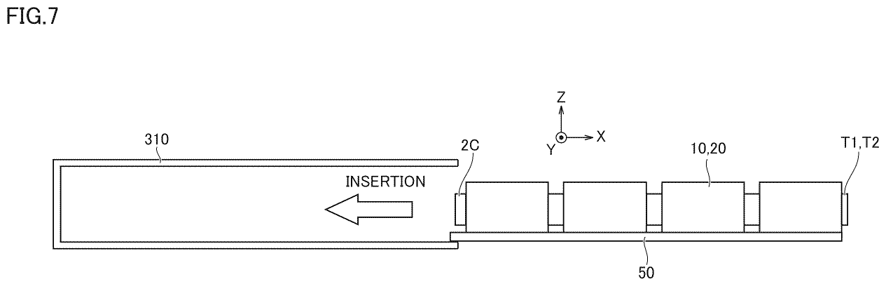

FIG. 7 is a diagram for illustrating functions and effects achieved by battery 100 according to this embodiment. Battery 100 includes casing 300, cell connected bodies 10 and 20, and base member 50 on which cell connected bodies 10 and 20 are carried as shown in FIG. 1. Cell connected bodies 10 and 20 and base member 50 are accommodated in casing 300. Casing 300 is in the shape of the parallelepiped having the X direction (the connection direction of each of cell connected bodies 10 and 20) as the longitudinal direction. In battery 100 constructed as such, base member 50 functions as a sliding board. By sliding base member 50 on which cell connected bodies 10 and 20 are carried toward casing 300 in the shape of the parallelepiped (more specifically, hollow main body 310 with bottom) as shown in FIG. 7, cell connected bodies 10 and 20 together with base member 50 can be inserted in main body 310 of casing 300. As cell connected bodies 10 and 20 are bonded to the first surface of base member 50, movement of cell connected bodies 10 and 20 away from base member 50 when cell connected bodies 10 and 20 as being carried on base member 50 are introduced in main body 310 can be suppressed. As the second surface of base member 50 is provided with sheet 70 (FIGS. 5 and 6) that lowers the coefficient of friction against the inner surface of main body 310 of casing 300, base member 50 more readily slides over the inner surface of main body 310. Projections 52 and 53 (FIGS. 5 and 6) not only stabilize a posture of cell connected bodies 10 and 20 while base member 50 slides over the inner surface of main body 310, but also functions as a guide for insertion. By inserting base member 50 into main body 310 until the end surface on the −X side of base member 50 abuts on the inner surface on the −X side of main body 310 (the surface opposite to the opening), cell connected bodies 10 and 20 are arranged at prescribed positions. Thus, according to the construction, cell connected bodies 10 and 20 are more readily appropriately inserted in casing 300. Since positional relation among the power storage cells hardly varies in insertion of base member 50, connection portions 2A to 2C are less likely to be damaged. After cell connected bodies 10 and 20 together with base member 50 are inserted in main body 310, main body 310 and lid body 320 are joined to each other as shown in FIG. 1. Main body 310 and lid body 320 are welded, for example, with laser.

As shown in FIGS. 1, 5, and 6, base member 50 is arranged on one surface F1 of the first opposing surfaces (surfaces F1 and F2) smaller in area than the second opposing surfaces (surfaces F3 and F4). As base member 50 is thus arranged on surface F1 smaller in area, the dimension of base member 50 is more readily made smaller. As the area of base member 50 is made smaller, slidability of base member 50 becomes higher. Without being limited as such, base member 50 may be provided on the second opposing surface instead of the first opposing surface.

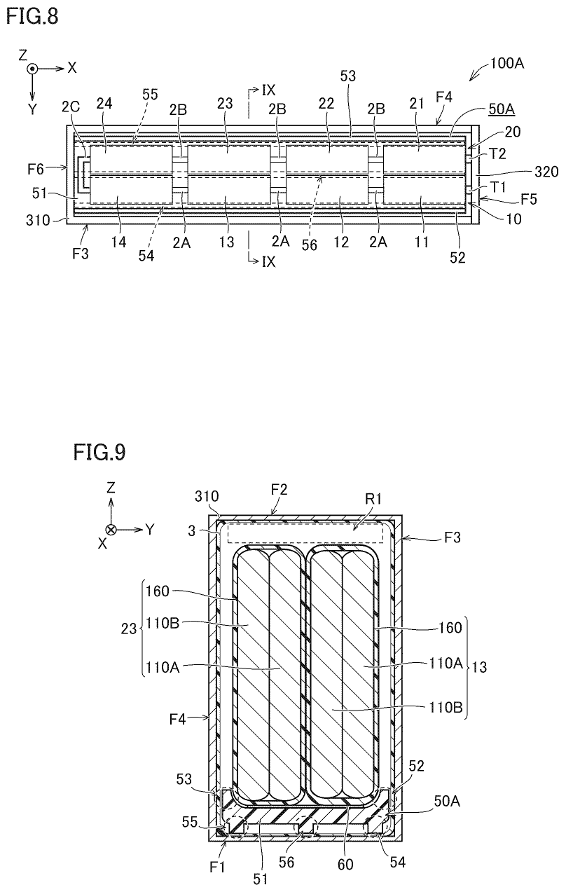

FIG. 8 is a diagram showing a first modification of the battery shown in FIG. 1. FIG. 9 is a cross-sectional view along the line IX-IX in FIG. 8.

As shown in FIG. 8, a battery 100A according to the first modification is basically similar in construction to battery 100 shown in FIG. 1. Battery 100A includes a base member 50A instead of base member 50 (FIG. 1). As shown in FIGS. 8 and 9, base member 50A further includes projections 54 to 56 that project from main body portion 51 toward the −Z side in addition to main body portion 51 and projections 52 and 53. Projections 54 and 55 are located at an end on the +Y side and at an end on the −Y side of main body portion 51, respectively. Projections 54 and 55 are located opposite to projections 52 and 53, respectively. Projection 56 is located between projection 54 and projection 55. Each of projections 54 to 56 is a linear projection that extends over substantially the entire region in the X direction of main body 310. Main body portion 51 and projections 52 to 56 may be an integrally formed article or such a composite that a plurality of separately formed members are joined to one another.

In battery 100A according to the first modification, linear projections 54 to 56 that extend in the X direction (the connection direction of each of cell connected bodies 10 and 20) are formed on the second surface of base member 50A. As projections 54 to 56 slide over the inner surface of main body 310 of casing 300, base member 50A is guided by projections 54 to 56 to more readily move in the X direction within main body 310. Base member 50A thus more readily linearly moves over the inner surface of main body 310, with linear projections 54 to 56 being interposed. Cell connected bodies 10 and 20 as being carried on base member 50A are thus more readily appropriately introduced in main body 310.

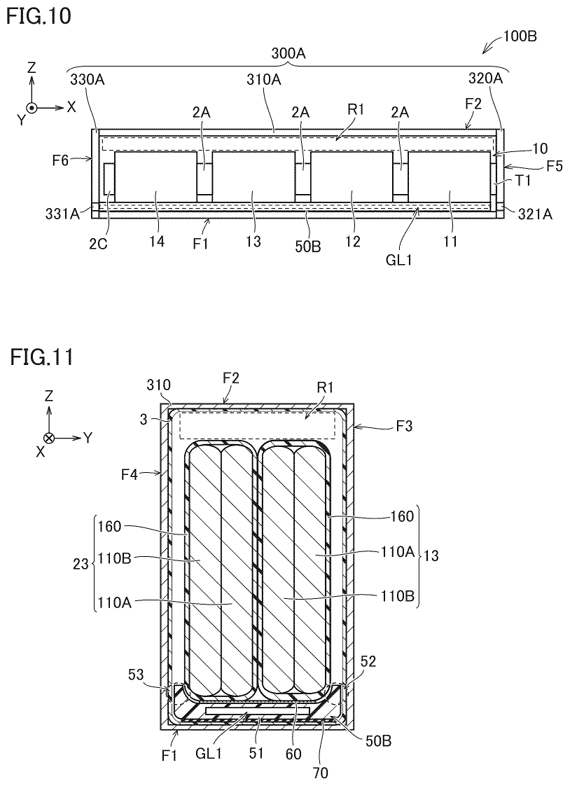

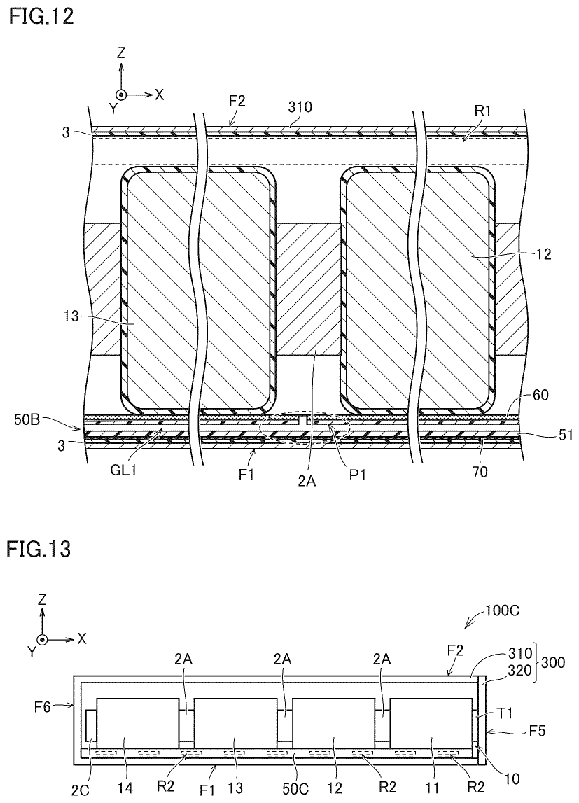

FIG. 10 is a diagram showing a second modification of the battery shown in FIG. 1. FIG. 11 is a cross-sectional view corresponding to FIG. 5, of the power storage device according to the second modification. FIG. 12 is a cross-sectional view corresponding to FIG. 6, of the power storage device according to the second modification.

As shown in FIG. 10, a battery 100B according to the second modification is basically similar in construction to battery 100 shown in FIG. 1. Battery 100B includes a casing 300A instead of casing 300 (FIG. 1) and includes a base member 50B instead of base member 50 (FIG. 1). Casing 300A includes a main body 310A and lid bodies 320A and 330A.

Main body 310A is a hollow housing provided with openings in opposing end surfaces (the end surface on the +X side and the end surface on the −X side) in the X direction, and cell connected bodies 10 and 20 are accommodated therein. Lid body 320A is provided with a sealing hole 321A opposed in the X direction to base member 50B and closes the opening on the +X side in main body 310A. Lid body 330A is provided with a sealing hole 331A opposed in the X direction to base member 50B and closes the opening on the −X side in main body 310A. Each of sealing holes 321A and 331A has a sealing structure, for example, with a metallic cap (outside of the casing) and a sealing member (inside of the casing). While such a sealing structure ensures hermeticity in casing 300A, gas is emitted to the outside of casing 300A through sealing holes 321A and 331A when the pressure in casing 300A exceeds a prescribed level.

As shown in FIGS. 10 to 12, base member 50B is obtained by providing a flow path GLI in base member 50 (see FIG. 1). Flow path GLI is a flow path through which gas generated from the power storage cell is emitted. As shown in FIG. 12, in base member 50B, at a portion P1 between two power storage cells adjacent in the X direction, a through hole (for example, a hole that passes through in the Z direction) that allows communication of flow path GLI with a space between the power storage cells is provided. The through hole and flow path GLI guide to sealing hole 321A or 331A, gas generated from each power storage cell included in cell connected bodies 10 and 20 accommodated in casing 300A. Each of sealing holes 321A and 331A is constructed to emit gas in casing 300A to the outside of casing 300A. According to such a construction, gas generated from the power storage cell is more readily appropriately emitted.

Flow path GLI defines a cavity in the inside of base member 50B. Base member 50B thus has a hollow structure. Impact externally applied to casing 300A is thus more readily absorbed by base member 50B. Flow path GLI may be provided by mechanical working or provided chemically by etching or the like.

FIG. 13 is a diagram showing a third modification of the battery shown in FIG. 1. As shown in FIG. 13, a battery 100C according to the third modification is basically similar in construction to battery 100 shown in FIG. 1. Battery 100C includes a base member 50C instead of base member 50 (FIG. 1). Base member 50C is obtained by providing a cavity R2 that does not function as a gas emission flow path in base member 50 (see FIG. 1). A plurality of cavities R2 are provided in the inside of base member 50C. Base member 50C has a hollow structure. Impact externally applied to casing 300 is thus more readily absorbed by base member 50C. The plurality of cavities R2 may be cavities in a porous body. Cavity R2 may be used as a path for a heat medium (for example, refrigerant).

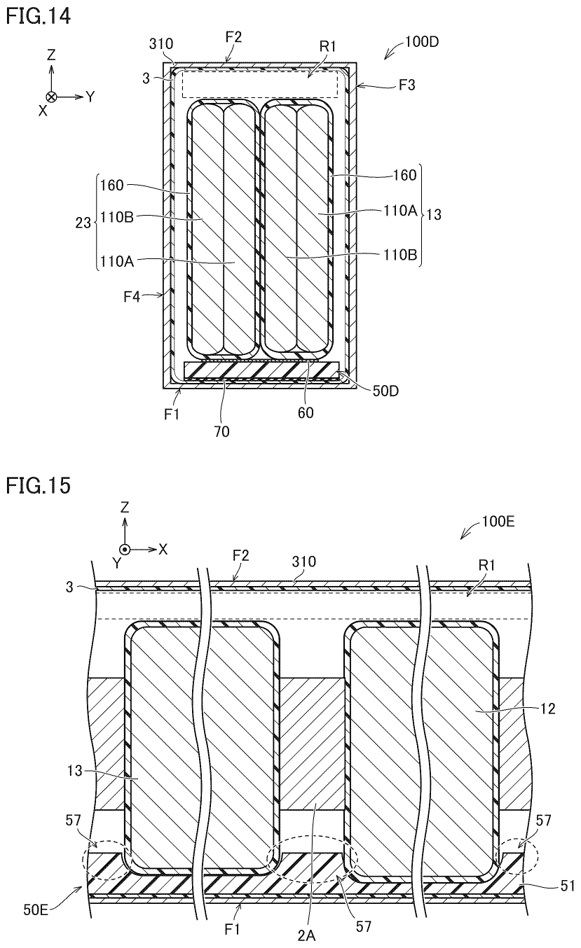

FIG. 14 is a diagram showing a fourth modification of the battery shown in FIG. 1. As shown in FIG. 14, a battery 100D according to the fourth modification is basically similar in construction to battery 100 shown in FIG. 1. Battery 100D includes a base member 50D instead of base member 50 (FIG. 1). Base member 50D is in a shape of a flat plate. Base member 50D is not provided with a projection. Base member 50D is readily manufactured. According to such a construction, manufacturing cost can be reduced.

FIG. 15 is a diagram showing a fifth modification of the battery shown in FIG. 1. As shown in FIG. 15, a battery 100E according to the fifth modification is basically similar in construction to battery 100 shown in FIG. 1. Battery 100E includes a base member 50E instead of base member 50 (FIG. 1). As shown in FIG. 15, base member 50E further includes a plurality of projections 57 that project from main body portion 51 toward the +Z side in addition to main body portion 51 and projections 52 and 53 shown in FIG. 5. Projection 57 is provided in cell connected body 10 at a position corresponding to each connection portion 2A. Though FIG. 15 shows only power storage cells 12 and 13 included in cell connected body 10, projection 57 is also provided in cell connected body 20 at a position corresponding to each connection portion 2B. Each of the plurality of projections 57 is located between two power storage cells adjacent in the X direction. Projection 57 is provided in every gap (connection portion 2A or 2B) between the power storage cells. As the plurality of projections 57 are formed in main body portion 51, cell connected bodies 10 and 20 placed on the first surface of base member 50E are less likely to move. Therefore, adhesive 60 (FIG. 5) does not have to be used in base member 50E. Though sheet 70 (FIG. 5) is not provided in the example shown in FIG. 15, sheet 70 may be provided on the second surface of base member 50E.

The plurality of projections 57 are added, for example, to base member 50 shown in FIG. 1. Without being limited as such, the plurality of projections 57 may be added to base member 50A (FIG. 8), base member 50B (FIG. 10), base member 50C (FIG. 13), or base member 50D (FIG. 14).

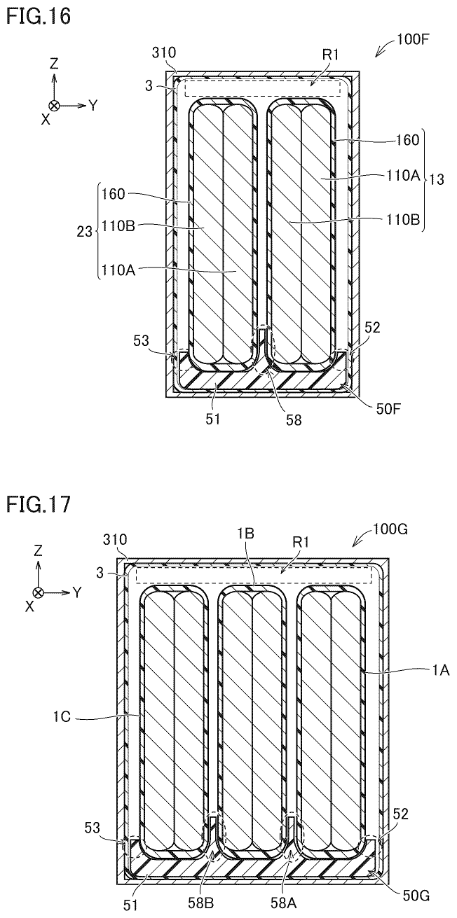

FIG. 16 is a diagram showing a sixth modification of the battery shown in FIG. 1. As shown in FIG. 16, a battery 100F according to the sixth modification is basically the same in cross-sectional structure as battery 100 shown in FIG. 5. Battery 100F includes a base member 50F instead of base member 50 (FIG. 1). In battery 100F, a gap is provided between the power storage cell (for example, power storage cell 13) in cell connected body 10 and the power storage cell (for example, power storage cell 23) in cell connected body 20 adjacent to each other in the Y direction. Base member 50F includes a projection 58 formed to enter the gap. Projection 58 is a linear projection that extends in the X direction (the connection direction of each of cell connected bodies 10 and 20) and projects toward the +Z side. Projection 58 has a dimension (dimension in the Y direction) corresponding to an interval between the power storage cells and functions as a spacer. As shown, for example, in FIG. 16, projection 58 restricts movement of power storage cell 13 toward the −Y side and movement of power storage cell 23 toward the +Y side and suppresses power storage cells 13 and 23 coming too close to each other.

In the first surface of base member 50F, a first recess which the end on the −Z side of each power storage cell (including power storage cell 13) included in cell connected body 10 (first cell connected body) enters is provided between projection 52 and projection 58. In the first surface of base member 50F, a second recess which the end on the −Z side of each power storage cell (including power storage cell 23) included in cell connected body 20 (second cell connected body) enters is provided between projection 53 and projection 58. By introducing cell connected bodies 10 and 20 in the first recess and the second recess, respectively, cell connected bodies 10 and 20 as being carried on base member 50F are more readily appropriately introduced in main body 310 of casing 300.

In base member 50F, adhesive 60 (FIG. 5) is not used. Therefore, cell connected bodies 10 and 20 carried on the first surface of base member 50F are slidable in the connection direction (X direction) with respect to base member 50F. According to such a construction, after cell connected bodies 10 and 20 as being carried on base member 50F are introduced in main body 310, cell connected bodies 10 and 20 can be slid in the connection direction with respect to base member 50F. Though sheet 70 (FIG. 5) is not provided either in the example shown in FIG. 16, sheet 70 may be provided on the second surface of base member 50F.

The number of cell connected bodies to be accommodated in the casing is not limited to two and any number of cell connected bodies may be accommodated therein. Three or more cell connected bodies or a single cell connected body may be accommodated in the casing.

FIG. 17 is a diagram showing a seventh modification of the battery shown in FIG. 1. As shown in FIG. 17, a battery 100G according to the seventh modification is basically the same in cross-sectional structure as battery 100 shown in FIG. 5. Battery 100G includes a base member 50G instead of base member 50 (FIG. 1). In battery 100G, three rows of cell connected bodies are accommodated in casing 300. Base member 50G includes, in addition to main body portion 51 formed in the shape of the plate on the X-Y plane and projections 52 and 53 located on opposing sides in the Y direction of the three rows of cell connected bodies, a projection 58A formed to enter a gap between a power storage cell 1A in a first cell connected body and a power storage cell 1B in a second cell connected body and a projection 58B formed to enter a gap between power storage cell 1B in the second cell connected body and a power storage cell 1C in a third cell connected body. Each of projections 52, 53, 58A, and 58B projects from main body portion 51 toward the +Z side.

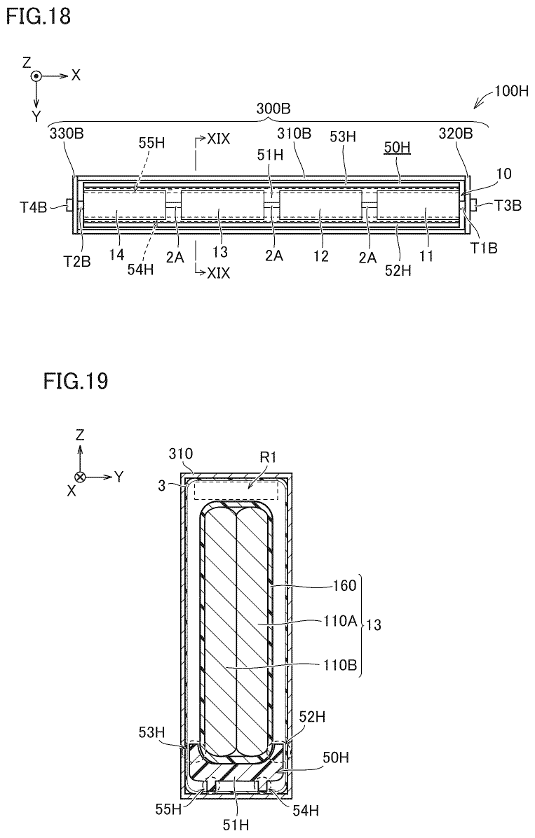

In the first surface of base member 50G, a first recess which an end on the −Z side of each power storage cell (including power storage cell 1A) included in the first cell connected body enters is provided between projection 52 and projection 58A. In the first surface of base member 50G, a second recess which an end on the −Z side of each power storage cell (including power storage cell 1B) included in the second cell connected body enters is provided between projection 58A and projection 58B. In the first surface of base member 50G, a third recess which an end on the −Z side of each power storage cell (including power storage cell 1C) included in the third cell connected body enters is provided between projection 58B and projection 53. By introducing the first cell connected body, the second cell connected body, and the third cell connected body in the first recess, the second recess, and the third recess, respectively, the first to third cell connected bodies as being carried on base member 50G are more readily appropriately introduced in main body 310 of casing 300. Though adhesive 60 and sheet 70 shown in FIG. 5 are not used in the example shown in FIG. 17, at least one of adhesive 60 and sheet 70 may be provided in base member 50G. FIG. 18 is a diagram showing an eighth modification of the battery shown in FIG. 1. FIG. 19 is a cross-sectional view along the line XIX-XIX in FIG. 18.

As shown in FIG. 18, a battery 100H according to the eighth modification includes a casing 300B as well as cell connected body 10 and a base member 50H accommodated in casing 300B. Cell connected body 10 is accommodated in casing 300B but cell connected body 20 is not accommodated in casing 300B. Casing 300B includes a main body 310B and lid bodies 320B and 330B. Main body 310B is a hollow housing provided with openings in opposing end surfaces in the X direction (the end surface on the +X side and the end surface on the −X side), and one cell connected body (cell connected body 10) is accommodated in main body 310B. Lid body 320B closes the opening on the +X side in main body 310B. Lid body 330B closes the opening on the −X side in main body 310B. Lid bodies 320B and 330B are provided with electrode tabs T3B and T4B, respectively. A connection terminal T1B is provided in power storage cell 11 located at one end (+X side) in the X direction of cell connected body 10, and a connection terminal T2B is provided in power storage cell 14 located at the other end (−X side) in the X direction of cell connected body 10. Electrode tabs T3B and T4B are electrically connected to respective connection terminals T1B and T2B. Electrode tabs T3B and T4B function, for example, as the negative electrode tab and the positive electrode tab, respectively. Without being limited as such, with polarity being reversed, electrode tab T4B may serve as the negative electrode tab and electrode tab T3B may serve as the positive electrode tab.

As shown in FIG. 19, base member 50H further includes a main body portion 51H in a shape of a plate, projections 52H and 53H that project from main body portion 51H toward the +Z side, and projections 54H and 55H that project from main body portion 51H toward the −Z side. Projections 52H and 53H are located at an end on the +Y side and an end on the −Y side on the first surface of base member 50H, respectively. Projections 54H and 55H are located at an end on the +Y side and an end on the −Y side on the second surface of base member 50H, respectively. Each of projections 52H to 55H is a linear projection that extends over substantially the entire region in the X direction of main body 310B.

In the first surface of base member 50H, a recess (specifically, a groove in the X direction) which an end on the −Z side of each power storage cell (including power storage cell 13) included in cell connected body 10 enters is provided between projection 52H and projection 53H. Cell connected body 10 carried on the first surface of base member 50H is slidable in the connection direction with respect to base member 50H. Each power storage cell (including power storage cell 13) included in cell connected body 10 is movable along the groove in the X direction. Without being limited as such, cell connected body 10 may be bonded to base member 50H. On the second surface of base member 50H, linear projections 54H and 55H that project toward the −Z side are formed. Base member 50H more readily linearly moves in the X direction over the inner surface of main body 310 with projections 54H and 55H being interposed. Main body portion 51H and projections 52H to 55H may be an integrally formed article or such a composite that a plurality of separately formed members are joined to one another. A projection that projects toward the −Z side may further be formed between projection 54H and projection 55H on the second surface of base member 50H.

Batteries 100 and 100A to 100H and a modified form thereof described previously alone can function as the power storage device. A plurality of such batteries may be combined into a module.

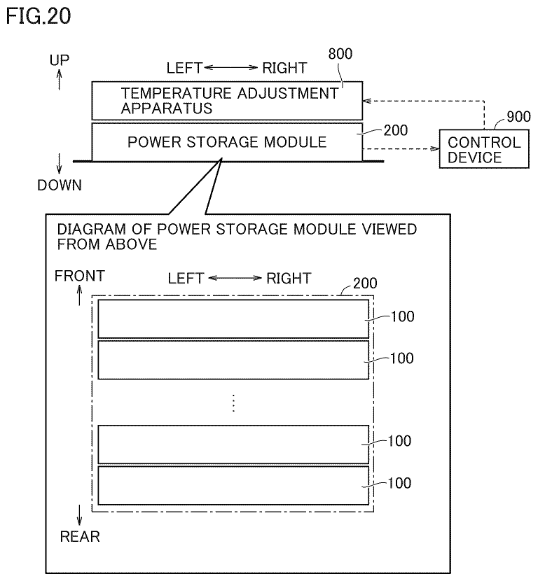

FIG. 20 is a diagram showing an exemplary power storage module including a plurality of batteries. FIG. 20 shows an upward-downward direction, a forward-rearward direction, and a left-right direction orthogonal to one another. “Down” corresponds to a vertical direction (a direction of gravity) and “up” refers to a direction opposite thereto. A figure showing the power storage module viewed from above shows an internal structure of a power storage module 200.

Power storage module 200 shown in FIG. 20 includes a plurality of batteries 100. In power storage module 200, the plurality of batteries 100 (see FIG. 1) are arranged such that a surface on the +Z side of each battery faces up and a surface on the −Z side of each battery faces down. For each of the plurality of batteries 100, which of the left and the right lid body 320 (the surface on the +X side) shown in FIGS. 1 and 2 should face can freely be set. For example, orientations of all batteries 100 may be aligned in power storage module 200. Alternatively, power storage module 200 may include both of battery 100 lid body 320 of which faces the right and battery 100 lid body 320 of which faces the left. The plurality of batteries 100 may be connected electrically in series or in parallel. Power storage module 200 functions as the power storage device.

In the example shown in FIG. 20, a temperature adjustment apparatus 800 is provided on an upper surface of power storage module 200. Temperature adjustment apparatus 800 is configured to adjust a temperature of each of the plurality of batteries 100 included in power storage module 200. Temperature adjustment apparatus 800 may include at least one of a heater and a cooler. Temperature adjustment apparatus 800 is controlled by a control device 900. Control device 900 includes, for example, a processor and a storage device, and it is connected through a signal line to connector 323 (FIG. 1) of each of the plurality of batteries 100 included in power storage module 200. Control device 900 receives a signal (for example, a sensor detection value) from connector 323 of each battery and sends a control command to temperature adjustment apparatus 800. Control device 900 may control temperature adjustment apparatus 800 based on a state of each battery. In power storage module 200, another battery (any of batteries 100A to 100H or a battery obtained by making various modifications described previously to the construction thereof) may be adopted instead of battery 100. Temperature adjustment apparatus 800 may be provided on a lower surface of power storage module 200.

Batteries 100 and 100A to 100H and the modified form thereof described previously and power storage module 200 may be mounted, for example, on a mobile body. Examples of the mobile body include a car (a battery electric vehicle, a hybrid electric vehicle, or the like), a vehicle other than the car (a ship, an airplane, or the like), a mobile machine (an agricultural machine, a construction machine, or the like), and an unmanned mobile body (an automated guided vehicle, a robot, or the like). Any application of the power storage device may be appliable, and the power storage device may be for a stationary use.

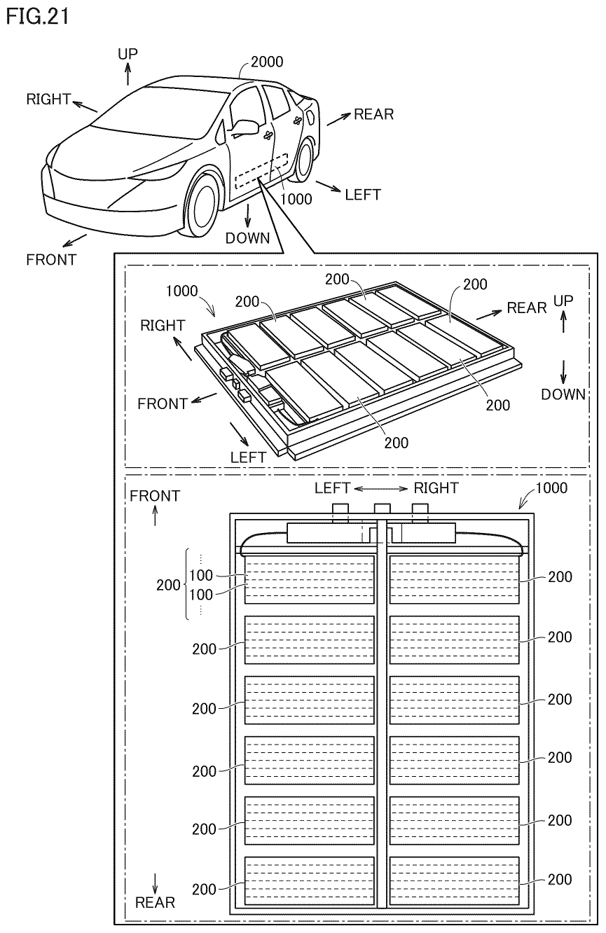

FIG. 21 is a diagram showing an exemplary vehicle on which the power storage module shown in FIG. 20 is mounted. A vehicle 2000 shown in FIG. 21 includes a battery pack 1000. Battery pack 1000 includes a plurality of power storage modules 200 and functions as the power storage device. Battery pack 1000 may further include temperature adjustment apparatus 800 shown in FIG. 20. Battery pack 1000 may be placed on or below a floor of vehicle 2000. Vehicle 2000 is a battery electric vehicle configured to travel with electric power outputted, for example, from battery pack 1000. Battery pack 1000 may supply electric power to a travel motor mounted on vehicle 2000. In battery pack 1000, power storage modules 200 are electrically connected to one another, for example, through a bus bar. Battery pack 1000 may include at least one hundred power storage cells.

Various characteristics (characteristics described in the embodiment and the modifications) in connection with the power storage devices described above may freely be combined and carried out. The power storage device may be applied to an apparatus other than the vehicle.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power storage device configured to store electric power, the power storage device comprising:
a casing;
one or more cell connected bodies; and
a base member on which the one or more cell connected bodies are carried, wherein
each of the one or more cell connected bodies includes a plurality of power storage cells and a connection portion that electrically connects the power storage cells to each other, and
the one or more cell connected bodies and the base member are accommodated in the casing.

2. The power storage device according to claim 1, wherein
the casing is in a shape of a parallelepiped having a longitudinal direction extending in a connection direction of each of the one or more cell connected bodies.

3. The power storage device according to claim 2, wherein
the casing is provided with four surfaces that extend in the connection direction of each of the one or more cell connected bodies and two surfaces that cover ends of the one or more cell connected bodies,
the four surfaces include first opposing surfaces which are a pair of surfaces opposed to each other and second opposing surfaces which are opposing surfaces larger in area than the first opposing surfaces, and
the base member is arranged on one of the first opposing surfaces.

4. The power storage device according to claim 1, wherein
the one or more cell connected bodies are bonded to the base member.

5. The power storage device according to claim 1, wherein
the one or more cell connected bodies are slidable in a connection direction thereof with respect to the base member.

6. The power storage device according to claim 1, wherein
the base member is in a shape of a flat plate.

7. The power storage device according to claim 1, wherein
the base member is in a shape having a U-shaped cross-section.

8. The power storage device according to claim 1, wherein
a surface of the base member on which the one or more cell connected bodies are placed is provided with one or more recesses which a part of the one or more cell connected bodies enters.

9. The power storage device according to claim 1, wherein
the one or more cell connected bodies include a first cell connected body and a second cell connected body electrically connected to each other, and
a surface of the base member on which the one or more cell connected bodies are placed is provided with a first recess which a part of the first cell connected body enters and a second recess which a part of the second cell connected body enters.

10. The power storage device according to claim 1, wherein
a surface of the base member opposite to a surface of the base member on which the one or more cell connected bodies are placed is provided with a linear projection that extends in a connection direction of each of the one or more cell connected bodies.

11. The power storage device according to claim 1, wherein
a surface of the base member opposite to a surface of the base member on which the one or more cell connected bodies are placed is provided with a sheet that lowers a coefficient of friction against an inner surface of the casing.

12. The power storage device according to claim 1, wherein
the base member is provided with a flow path through which gas generated from at least one of the plurality of power storage cells is emitted.

13. A vehicle comprising the power storage device according to claim 1.
